(19) United States
(12) Patent Application Publication
(10) Pub. No.: US 2013/0283621 A1
(43) Pub. Date: Oct. 31, 2013

(54) LOCKING MECHANISM FOR A PUSH BUTTON ACTIVATED FOLDING TOOL

(71) Applicants: Douglas S. Snyder, Littleton, CO (US); Tom D. Koenig, Lakewood, CO (US)

(72) Inventors: Douglas S. Snyder, Littleton, CO (US); Tom D. Koenig, Lakewood, CO (US)

(73) Assignee: SPYDERCO, INC., Golden, CO (US)

(21) Appl. No.: 13/460,370

(22) Filed: Apr. 30, 2012

(51) Int. Cl. B26B 1/04; B25G 1/08

(52) U.S. Cl. 30/161; 81/489

(57) ABSTRACT

A folding tool with an improved locking mechanism is provided. The locking mechanism generally comprises a biasing member interconnected to a handle of the tool and coupled to an engagement member, which may be a push button. In various embodiments, the biasing member biases the engagement member towards a locked position in which a portion of the engagement member interacts with a tang of an implement to prevent rotation of the implement.

### FIELD

The present disclosure generally relates to folding tools. More specifically, the present disclosure relates to a folding tool with a locking mechanism in communication with an implement for selectively locking the implement in an open or closed position.

### BACKGROUND

Many folding tools utilize a locking mechanism that prevents the implement from opening and/or closing unintentionally. For example, existing locking mechanisms for folding knives include “back locks” and “liner locks”. The back lock utilizes a generally metallic member that rides on the back of the blade as the blade rotates between a closed position and an open position. Once the blade is in an open position, the back lock member pivots into place behind a flat portion of the tang of the blade, thereby preventing closure of the blade until the back lock member is manually pivoted out of the way of the blade. The liner lock utilizes a thin, generally metallic liner that springs into place behind a flat portion of the tang of the blade, thereby preventing closure until the liner is manually moved out of the way of the blade. In some situations, the back lock and the liner lock have proven to be unreliable. For example, extended use of the back lock and the liner lock, especially in harsh environments, can result in corrosion and wear issues. An example of a liner lock is discussed in U.S. Pat. No. 8,042,276, which is hereby incorporated by reference in its entirety.

As an alternative to the back lock and the liner lock, some lock mechanisms utilize a push button as a lock. To bias the push button into a locked position, a compression spring is positioned coaxially with the pivot axis between the push button and the handle of the folding knife. The addition of a compression spring increases the number of components associated with the locking mechanism, which increases the likelihood of problems. In addition, to accommodate the lack of space between the push button and the handle, a recess is typically formed in the end of the button to at least partially house the compression spring. The recess formed in the button weakens the lock mechanism as the hollow portion of the button typically interacts with the tang of the blade to lock the rotation of the blade. To further accommodate the compression spring, a recess may be formed in the handle as well. However, a recess formed in the handle cannot extend through the handle because the handle acts as a reacting surface for the compression spring. Thus, the handle encloses the locking mechanism and traps water and/or debris within the critical moving parts of the folding knife, which may include the locking mechanism and the pivot axis of the blade. In many situations, trapped water and/or debris can result in corrosion and interfere with the operation of the knife. This problem is accentuated when the folding knife is exposed to harsh environments, including underwater applications.

Based upon at least the aforementioned problems, there exists a long-felt and unsolved need to provide a folding tool with a strong lock mechanism that reduces the number of components utilized in the locking mechanism and that allows drainage of water and/or removal of debris from the critical moving parts of the tool, including the locking mechanism.

### SUMMARY

Embodiments of the locking mechanism disclosed herein can be utilized with any type or form of folding tool or apparatus with a deployable implement or member. For example, embodiments of the locking mechanism disclosed herein can be utilized with multi-tools having various implements including, but not limited to, an awl, a container opener, a driver, a file, a knife, a saw, and scissors. For purposes of illustration and clarity, the embodiments disclosed herein are discussed in relation to a folding knife with a rotatable blade.

Embodiments of the present disclosure generally relate to a folding knife comprising a blade, a handle, and a locking mechanism. In various embodiments, the blade is rotatable about a pivot axis that is generally perpendicular to a plane in which the blade rotates. In these embodiments, at least a rear portion of the blade, generally referred to as a tang, is disposed between a first handle portion and a second handle portion in both an open and closed position. Generally, the tang of the blade is rotatably interconnected to the handle, which is comprised of two opposing scales.

It is an aspect of the present disclosure to provide a folding knife utilizing a push button as a lock. In one embodiment, when the push button is in a locked position, a portion of the push button interacts with a tang of a blade to prevent rotation of the blade. In one embodiment, when the push button is in an unlocked or depressed position, a notch formed in the button is configured to allow the tang of the blade to pass through the notch during rotation of the blade.

It is another aspect of the present disclosure to provide a folding knife having a locking mechanism biased toward a locked position. In one embodiment, the locking mechanism comprises a push button coupled to a biasing member. In various embodiments, the biasing member biases the push button towards a locked position in which a portion of the button prevents rotation of a blade of the folding knife. In these embodiments, by depressing the push button, a user can release the lock mechanism to selectively allow rotation of the blade. Further, the biasing member may provide a linear and/or non-linear biasing force.

It is a further aspect of the present disclosure to provide a folding knife with a stronger lock mechanism than existing lock mechanisms. In one embodiment, a push button is coupled to a biasing member, and the biasing member biases the push button towards a locked position in which a portion of the button prevents rotation of a blade of the folding knife. In various embodiments, the biasing member interacts with a sidewall of the button to bias the button. For example, in one embodiment, a free end of the biasing member contacts the sidewall to bias the push button. In another embodiment, a free end of the biasing member extends into a hole formed in the sidewall to bias the push button. In these embodiments, the push button does not require a recession to house a compression spring, as is required in existing button locks. Thus, in these embodiments, a stronger lock mechanism is provided than in existing button locks.

It is an aspect of the present disclosure to provide a folding knife having a locking mechanism utilizing a laterally displaceable biasing member interconnected to a handle of a folding knife. In one embodiment, a locking mechanism comprises an engagement member and a biasing member. The engagement member generally interacts with the blade of the folding knife to lock the blade in an open or closed position. In one embodiment, the engagement member comprises a push button. The biasing member generally biases the engagement member outwardly towards a locked position in which a portion of the engagement member locks the folding knife and prevents rotation of the blade. In one embodiment, the biasing member comprises a sidespring. The sidespring, in one embodiment, is integrally interconnected to a handle. For example, in various embodiments, the sidespring may be formed in the handle. In these embodiments, various manufacturing methods can be utilized to form the sidespring, including, but not limited to, molding, cutting, or machining, as known in the art. If formed in the handle, the sidespring and the handle comprise a single component of the folding knife, thus reducing the need for additional components and/or material to interconnect or position the sidespring within the handle. This is advantageous because in certain environments, including marine applications, reducing the number of components that will be exposed to the harsh environment results in a more robust knife with a reduced likelihood of failure. In alternative embodiments, the sidespring can be interconnected to a handle portion using methods known in the art, including, but not limited to, adhesives, fasteners, and welding.

Another aspect of the present disclosure is to provide a lockable folding knife with improved drainage of water and/or removal of debris out of the moving parts of the folding knife. In one embodiment, an aperture is formed in the handle of the folding knife to accommodate an engagement member, which may be a button, operating as a lock. The aperture allows water to drain and/or debris to be removed out of the folding knife, thus reducing factors that lead to corrosion within the critical moving parts of the knife. For example, a handle aperture provides easy drainage of water from within the knife, which, if not drained, can cause corrosion. As another example, a handle aperture provides easy removal of debris trapped within the folding knife, which, if not removed, can affect the operation of the knife, particularly the rotation of the blade and the displacement of the locking mechanism. Existing button lock folding knifes do not utilize an aperture in the handle of the folding knife because a compression spring housed within the folding knife requires the handle to have a solid surface for the compression spring to properly bias the button into a locked position.

The embodiments discussed herein can be modified to be used in association with any folding tool or apparatus with a rotatable implement or member. The embodiments discussed herein also can be modified to be used in association with any folding knife with a rotatable blade. For example, embodiments of the present disclosure can be utilized with automatic knives, spring-assisted knives, and manual opening folding knives. Similarly, embodiments of the present disclosure may be adapted for use with any type of handle. For example, as used herein, a ‘handle portion’ can refer to a scale, a liner, a spacer, or any combinations thereof. The terms first and second are not intended to connote importance or priority, but are used to distinguish one component from another. Embodiments of knives discussed herein may be constructed of any materials now known or later developed in the art, including, but not limited to, aluminum, steel, stainless steel, and various forms of plastics.

The phrases “at least one”, “one or more”, and “and/or”, as used herein, are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

The term “a” or “an” entity, as used herein, refers to one or more of that entity. As such, the terms “a” (or “an”), “one or more” and “at least one” can be used interchangeably herein.

The use of “including,” “comprising,” or “having” and variations thereof herein is meant to encompass the items listed thereafter and equivalents thereof as well as additional items. Accordingly, the terms “including,” “comprising,” or “having” and variations thereof can be used interchangeably herein.

It shall be understood that the term “means” as used herein shall be given its broadest possible interpretation in accordance with 35 U.S.C., Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary of the invention, brief description of the drawings, detailed description, abstract, and claims themselves.

The Summary is neither intended nor should it be construed as being representative of the full extent and scope of the present disclosure. The present disclosure is set forth in various levels of detail in the Summary as well as in the attached drawings and the Detailed Description and no limitation as to the scope of the claimed subject matter is intended by either the inclusion or non-inclusion of elements, components, etc. in this Summary. Moreover, reference made herein to “the present invention” or aspects thereof should be understood to mean certain embodiments of the present disclosure and should not necessarily be construed as limiting all embodiments to a particular description.

### BRIEF DESCRIPTION OF THE DRAWINGS

The accompanying drawings, which are incorporated in and constitute a part of the specification, illustrate embodiments of the disclosure and together with the general description given above and the detailed description of the drawings given below, serve to explain the principles of these embodiments.

FIG. 1 is an exploded front perspective view of an embodiment of a folding knife in an open position;

FIG. 2 is a front perspective view of an embodiment of a partially assembled folding knife in an open position;

FIG. 3 is a front perspective view of an embodiment of a partially assembled folding knife in a closed position;

FIG. 4 is a front elevation view of an embodiment of a partially fragmented folding knife in an open position;

FIG. 5A is a cross-section view taken along line A-A of the folding knife shown in FIG. 4 in a locked position;

FIG. 5B is a cross-section view taken along line A-A of the folding knife shown in FIG. 4 in an unlocked position;

FIG. 6 is a front elevation view of an embodiment of a partially fragmented folding knife in a closed position;

FIG. 7 is a cross-section view taken along line B-B of the folding knife shown in FIG. 6 in a locked position;

FIG. 8 is a top plan view of an embodiment of a liner;

FIG. 9 is a front elevation view of an embodiment of a liner;

FIG. 10 is a front perspective view of an embodiment of a button;

FIG. 11 is a top plan view of the button shown in FIG. 10;

FIG. 12 is a side elevation view of the button shown in FIG. 10; and

FIG. 13 is a front elevation view of the button shown in FIG. 10.

It should be understood that the drawings are not necessarily to scale. In certain instances, details that are not necessary for an understanding of the disclosure or that render other details difficult to perceive may have been omitted. It should be understood, of course, that the claimed invention is not necessarily limited to the particular embodiments illustrated herein.

To assist in the understanding of the drawings, the following is a list of components and associated numbering found in the drawings:

| # | Components |
|---|---|
| 2 | Folding knife |
| 6 | Blade |
| 6A | Front end of blade |
| 6B | Rear end of blade |
| 10 | First handle portion |
| 14 | Second handle portion |
| 18 | First liner |
| 18A | Forward portion of first liner |
| 22 | First scale |
| 22A | Forward portion of first scale |
| 26 | Second liner |
| 26A | Forward portion of second liner |
| 30 | Second scale |
| 30A | Forward portion of second scale |
| 34 | Aperture |
| 38 | Push button (or, alternatively, engagement member) |
| 42 | First end of push button or engagement member |
| 46 | Recessed portion |
| 50 | Second end of push button or engagement member |
| 54 | Receiving hole |
| 56 | Sidewall |
| 58 | Free end (or, alternatively, second end) |
| 62 | Biasing member |
| 66 | Fixed end (or, alternatively, first end) |
| 70 | Tang |
| 74 | Stop pin contact surface |
| 78 | Stop pin aperture |
| 82 | Open position button contact surface |
| 86 | Closed position button contact surface |
| 90 | Concave surface |
| 94 | Contoured grip |
| 98 | Convex surface |
| 106 | Notch |
| 114 | Predetermined width |
| 118 | Alignment surface |
| 122 | Liner |
| 122A | First end of liner |
| 122B | Second end of liner |
| 126 | First cylindrical portion of sidewall |
| 130 | Second cylindrical portion of sidewall |
| 134 | Ramp portion of sidewall |
| 138 | Third cylindrical portion of sidewall |

### DETAILED DESCRIPTION

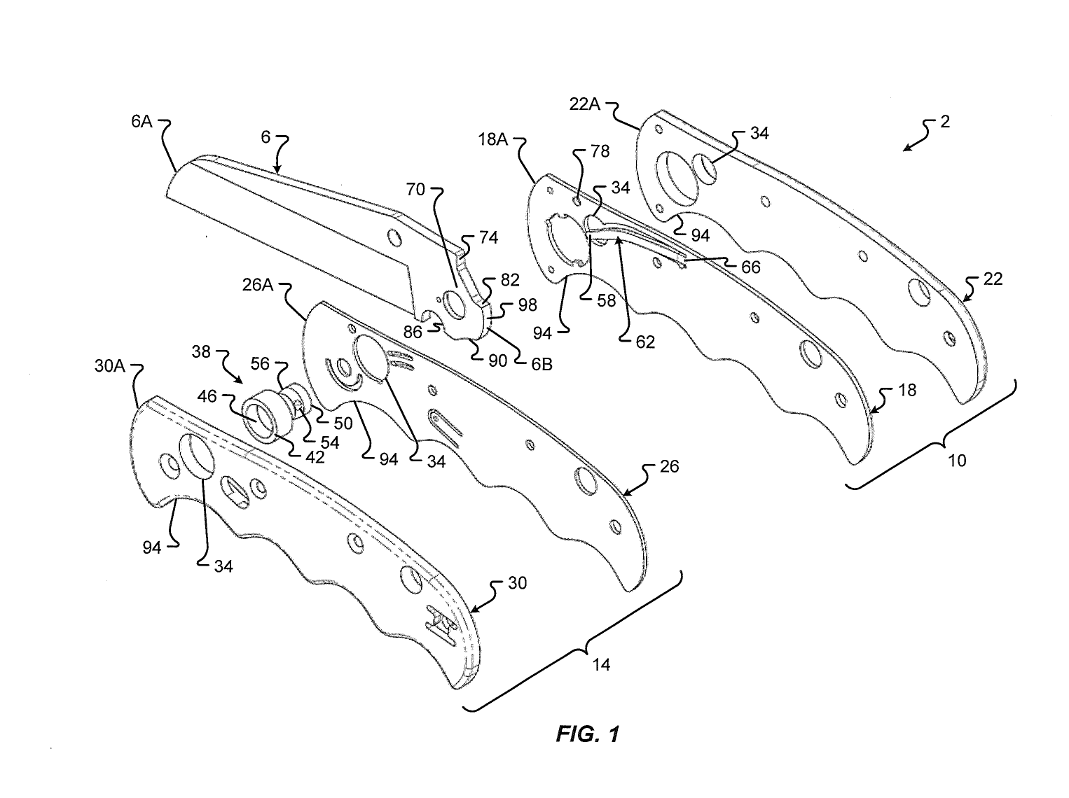

With reference to FIG. 1, an exploded perspective view of one embodiment of a locking folding knife 2 in an open position is provided. In this embodiment, the folding knife 2 comprises a blade 6 and a handle. The blade 6 is positioned between a first handle portion 10 and a second handle portion 14. The first handle portion 10 comprises a first liner 18 and a first scale 22, and the second handle portion 14 comprises a second liner 26 and a second scale 30. In the depicted embodiment, an aperture 34 extends through the handle, including the first handle portion 10 and the second handle portion 14, and is configured to accommodate a push button 38.

The push button 38 shown in FIG. 1 includes a first end 42 having a recessed portion 46 and a second end 50 having no recessed portion. The recessed portion 46 provides a means for a user to locate and index the button 38 and reduces the weight of the folding knife 2. The lack of a recessed portion in a second end 50 of the button 38 increases the strength of the button 38 and thus provides a stronger lock mechanism. In the embodiment of FIG. 1, the button 38 also includes a receiving hole 54 formed in a sidewall 56 of the button 38. The receiving hole 54 is configured to receive a free end 58 of a biasing member 62, which is interconnected to the first liner 18.

The biasing member 62 of FIG. 1 is integrally formed in the first liner 18. In the depicted embodiment, the biasing member 62 is an extension of the first liner 18. The biasing member 62 has a fixed end 66 that is integrally connected to the first liner 18, and a free end 58 that is laterally-displaceable relative to the fixed end 66 and to the first liner 18. The biasing member 62 biases the push button 38 towards a locked position in which a portion of the push button 38 interacts with a tang 70 of the blade 6 to prevent rotation of the blade 6. Although the illustrated embodiment depicts the biasing member 62 as being integrally formed in the first liner 18, it should be appreciated that in alternative embodiments the biasing member 62 can be a separate member interconnected to the first liner 18 using methods known in the art, including, but not limited to, adhesives, fasteners, and welding. Additionally, it should be appreciated that in alternative embodiments the biasing member 62 can be formed in and/or interconnected to various components of the handle. As can be appreciated, some folding knives do not have liners and the blade is positioned directly between the scales. In these types of folding knives, the biasing member 62 can be interconnected to, which may include being formed in, a scale. It is contemplated that embodiments of the locking mechanism discussed herein can be utilized with any variation of folding knife, including automatic, spring assist, and manual folding knives.

Referring back to the embodiment depicted in FIG. 1, a blade 6 includes a front end 6A and a rear end 6B. The rear end 6B includes a tang 70 configured to be rotatably interconnected to a forward portion 18A, 22A, 26A, 30A of the handle. The tang 70 includes a stop pin contact surface 74 to contact a stop pin, which interconnects to a stop pin aperture 78 formed in the first liner 18, when the blade 6 is in an open position. The stop pin contact surface 74 limits the rotation of the blade 6 and prevents over-rotation of the blade 6 in an open position. The tang 70 also includes an open position button contact surface 82. In an open position with the button 38 in a locked position, a portion of the push button 38 interacts with the contact surface 82 of the tang 70 to prevent rotation of the blade 6 towards a closed position. The tang 70 further includes a closed position button contact surface 86. In a closed position with the button 38 in a locked position, a portion of the push button 38 interacts with the contact surface 86 of the tang 70 to prevent rotation of the blade 6 towards an open position. Moreover, the tang 70 includes a concave surface 90 that matches the contoured grip 94 of the handle when the blade is in an open position, and a convex surface 98.

A method of assembling a locking mechanism of a folding knife 2 having a blade 6 and a handle according to an embodiment of the present disclosure is provided as well. In general, a blade 6 is provided that includes a tang 70 on a rear portion 6B, and a handle is provided with a first handle portion 10 and a second handle portion 14. The first handle portion 10 and the second handle portion 14 may include a liner, a scale, or various combinations thereof. In one configuration, the first handle portion 10 includes a liner 18 and a scale 22. In this configuration, a biasing member 62 is interconnected to the liner 18, and may be integrally formed with the liner 18. After interconnection, a laterally-displaceable free end 58 of the biasing member 62 is inserted into a receiving hole 54 formed in a sidewall 56 of a push button 38 to couple the button 38 to the biasing member 62. The button 38 is positioned within an aperture 34 formed in the first handle portion 10 and the second handle portion 14, and the first handle portion 10 and the second handle portion 14 are interconnected. In addition, a tang 70 of the blade 6 is rotatably interconnected to the handle. Although not depicted, various fasteners, pins, spacers, and other components may be utilized in assembling the folding knife 2, as is known in the art.

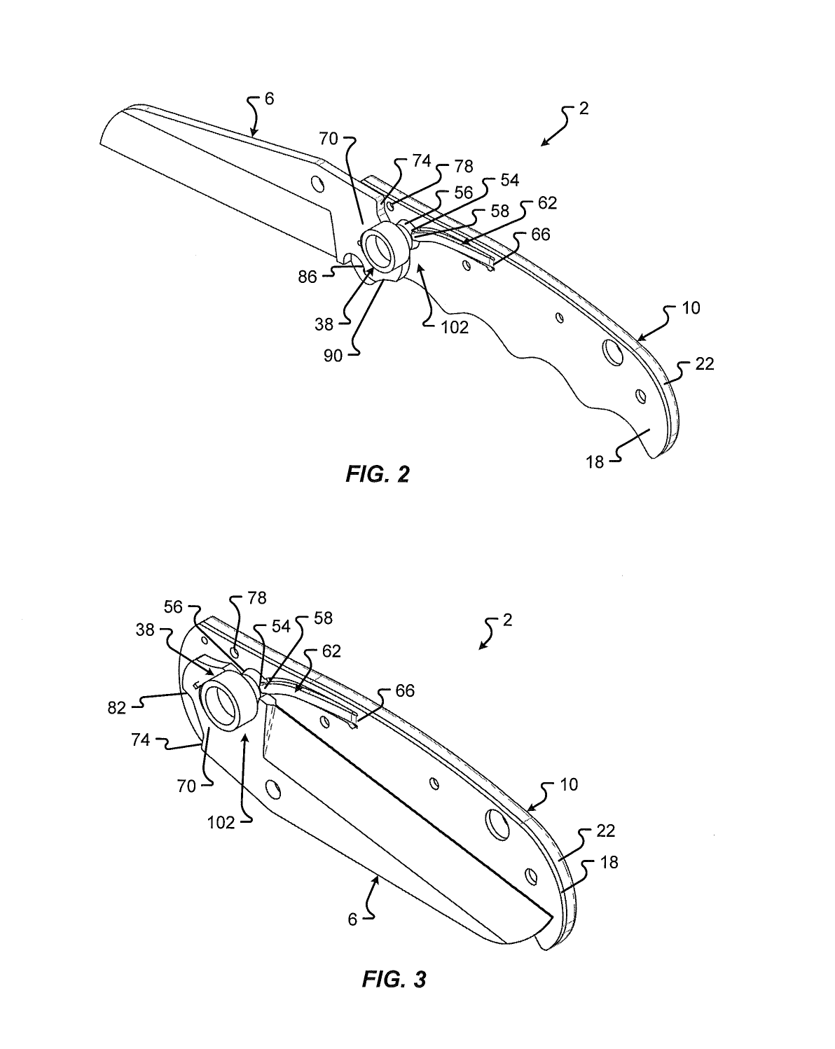

Referring now to FIGS. 2-3, a perspective view of an embodiment of a partially assembled folding knife 2 is provided. In the embodiment depicted in FIGS. 2-3, a blade 6 includes a tang 70 rotatably interconnected to a first handle portion 10 such that the blade 6 may be selectively rotated between an open and closed position. A second handle portion 14 has been removed in FIGS. 2-3 to illustrate a locking mechanism 102, which comprises a button 38 coupled to a biasing member 62, that locks the blade 6 in an open or closed position. As illustrated in FIGS. 2-3, a free end 58 of the biasing member 62 extends into a receiving hole 54 formed in a sidewall 56 of the push button 38 to couple the button 38 to the biasing member 62. In alternative embodiments, a push button 38 does not include a receiving hole 54. Rather, the free end 58 of the biasing member 62 contacts the sidewall 56 to couple the button 38 to the biasing member 62. For example, in an alternative embodiment, a sidewall 56 of the push button 38 may include a pair of flanges for the free end 58 to fit between or an annular groove for the free end 58 to reside within. Referring particularly to FIG. 2, the blade 6 is locked in an open position by the button 38 and a stop pin. Although the stop pin is not depicted, the stop pin attaches to the stop pin aperture 78 formed in the first handle portion 10 and contacts the stop pin contact surface 74 of the tang 70 to prevent over-rotation. A sidewall 56 of the button 38 interacts with the open position contact surface 82 of the tang 70 to prevent the blade 6 from being rotated toward a closed position. Referring to FIG. 3, the blade 6 is locked in a closed position by the button 38. A sidewall 56 of the button 38 interacts with the closed position contact surface 86 of the tang 70 to prevent the blade 6 from being rotated toward an open position.

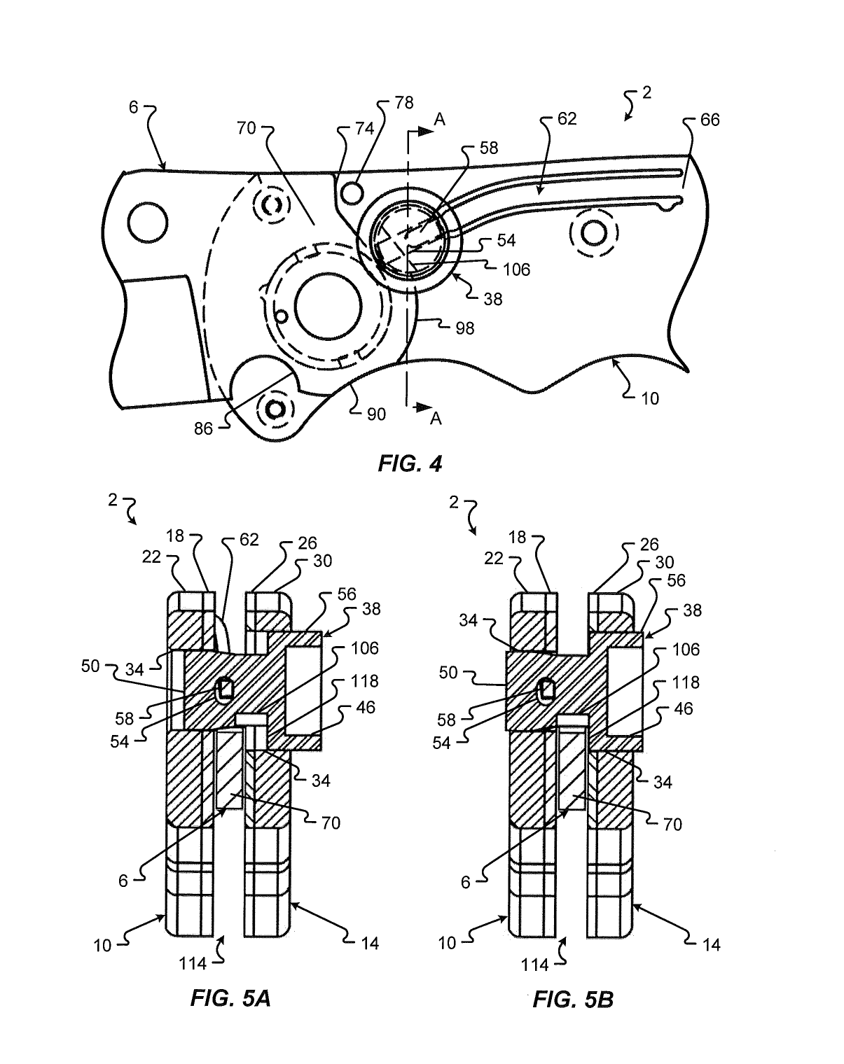

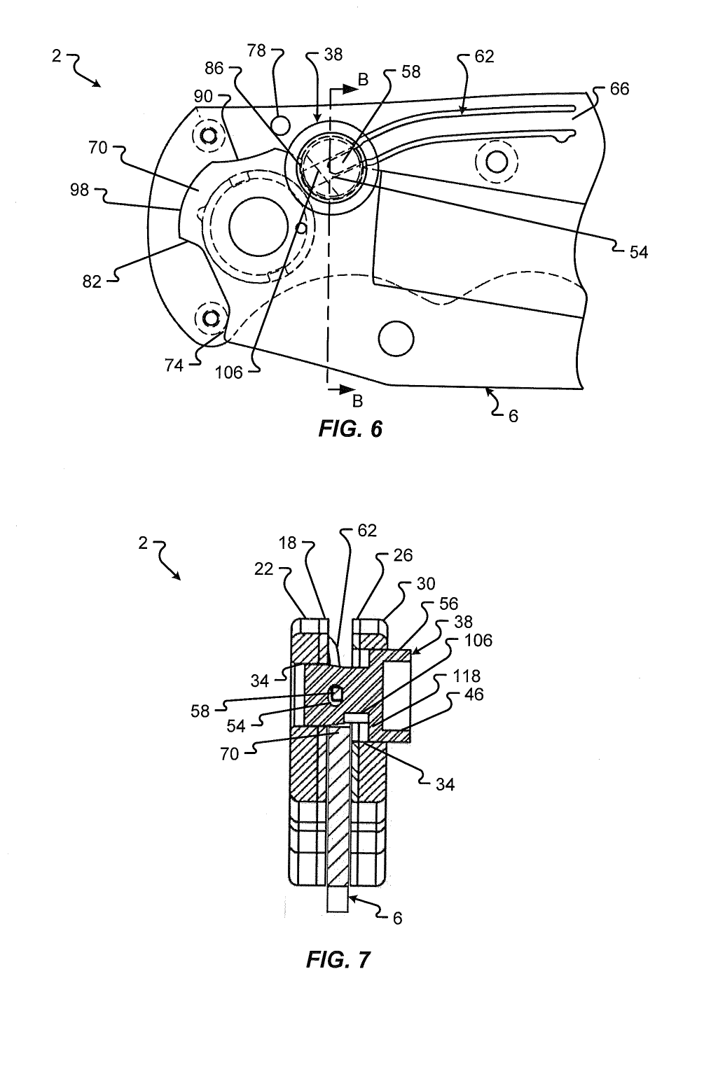

Referring to FIGS. 4 and 6, a front elevation view of an embodiment of a partially fragmented folding knife 2 in an open position and closed position, respectively, is depicted. In the embodiment depicted in FIGS. 4 and 6, a biasing member 62 has a fixed end 66 integrally formed in the first handle portion 10 and a free end 58 that extends into a receiving hole 54 formed in a push button 38. The receiving hole 54 is depicted as a through-hole, which advantageously allows water and debris to drain out of the button 38 to reduce corrosion. In an alternative embodiment, however, the receiving hole 54 is not a through-hole and only extends partially into the sidewall 56 of the button 38. In the depicted embodiment, a notch 106 is formed in the button 38 and configured to allow rotation of the blade 6 when the notch 106 is laterally aligned with the tang 70 of the blade 6. As depicted, the notch 106 is configured to allow the convex surface 98 of the tang 70 to rotate through the notch 106 without contacting an inner surface of the notch 106. When the button 38 is in an unlocked position and the blade 6 has been rotated such that the convex surface 98 of the tang 70 has entered the notch 106, the tang 70 holds the button 38 in an unlocked position and prevents the button 38 from locking during blade rotation between the open and closed position.

Referring now to FIGS. 5A and 7, FIG. 5A is a cross-section view taken along line A-A of the folding knife 2 shown in FIG. 4, and FIG. 7 is a cross-section view taken along line B-B of the folding knife 2 shown in FIG. 6. The depicted embodiments show a handle comprising a first handle portion 10 spaced apart from a second handle portion 14 by a predetermined width 114 that is based upon the width of the blade 6. As depicted, the tang 70 of the blade 6 is disposed between the first handle portion 10 and the second handle portion 14. A push button 38 is positioned within an aperture 34 formed in the first handle portion 10 and the second handle portion 14. The button 38 is coupled to a free end 58 of the biasing member 62, and, as illustrated, the button 38 is in a non-displaced position. In the embodiment depicted in FIG. 5A, the blade 6 is locked in an open position and a sidewall 56 of the button 38 prevents the tang 70 from rotating towards a closed position. In the embodiment depicted in FIG. 7, the blade 6 is locked in a closed position and a sidewall 56 of the button 38 prevents the tang 70 from rotating towards an open position. In both FIGS. 5A and 7, the free end 58 of the biasing member 62 biases the push button 38 towards this locked position. For example, by pushing the button 38 in a direction substantially transverse to the folding knife 2, the free end 58 of the biasing member 62 displaces laterally relative to a fixed end 66 of the biasing member 62 and to the first liner 18. The stiffness of the biasing member 62 resists the lateral displacement, and biases the push button 38 towards the non-displaced position in which a portion of the push button 38 interacts with the tang 70 of the blade 6 to prevent rotation of the blade 6.

FIG. 5B is a cross-section view taken along line A-A of the folding knife shown in FIG. 4 in an unlocked position. To unlock the blade 6, a user presses the push button 38 transverse to the folding knife 2 until an alignment surface 118 of the push button 38 abuts the tang 70, at which point the tang 70 of the blade is aligned with a notch 106 formed in the push button 38. The notch 106 is configured to accommodate the tang 70 and to allow the blade 6 to rotate between an open and closed position. Once the blade 6 has been rotated to a position between the open and closed positions, the tang 70 contacts the side surfaces of the notch 106 and prevents lateral displacement of the button 38. Once the blade 6 is rotated into an open or closed position, a biasing force, which may be linear and/or non-linear, of the biasing member 62 laterally displaces the button 38 into a locked position in which a portion of the push button 38 contacts the tang 70 to prevent rotation of the blade 6. As can be appreciated, if the folding knife 2 is an automatic knife, when the notch 106 is aligned with the tang 70 in a closed position, the blade 6 automatically rotates toward an open position. If the folding knife 2 is a non-automatic knife, a user can manually rotate the blade 6 towards an open position when the notch 106 is aligned with the tang 70.

Referring back to the embodiments illustrated in FIGS. 5A and 7, the free end 58 of the biasing member 62 is laterally offset from the liner 18 in a non-displaced position. In an alternative embodiment, the free end 58 of the biasing member 62 in a non-displaced position is coplanar with the liner 18 with no lateral offset. In this alternative embodiment, the receiving hole 52 is formed closer to the second end 50 of the push button 38 to accommodate the free end 58 of the biasing member 62. The locking mechanism, in this alternative embodiment, operates in the same fashion as described above with the biasing member 62 biasing the push button 38 towards a locked position.

In accordance with an embodiment of the present disclosure, a method of releasing a locking mechanism of a folding knife 2 having a blade 6 and a handle is provided. In this embodiment, the blade 6 generally includes a tang 70 rotatably interconnected to the handle. In various embodiments, to release the locking mechanism, a user pushes a button 38 in a direction substantially transverse to the folding knife 2. The button 38 displaces a free end 58 of a biasing member 62 laterally relative to a fixed end 66 of the biasing member 62. The user depresses the button 38 until a notch 106 formed in the button 38 is laterally aligned with the tang 70. Once aligned, the blade 6 can be rotated. Upon rotation of the blade 6 to an open or closed position, the free end 58 of the biasing member 62 displaces the button 38 into a locked position.

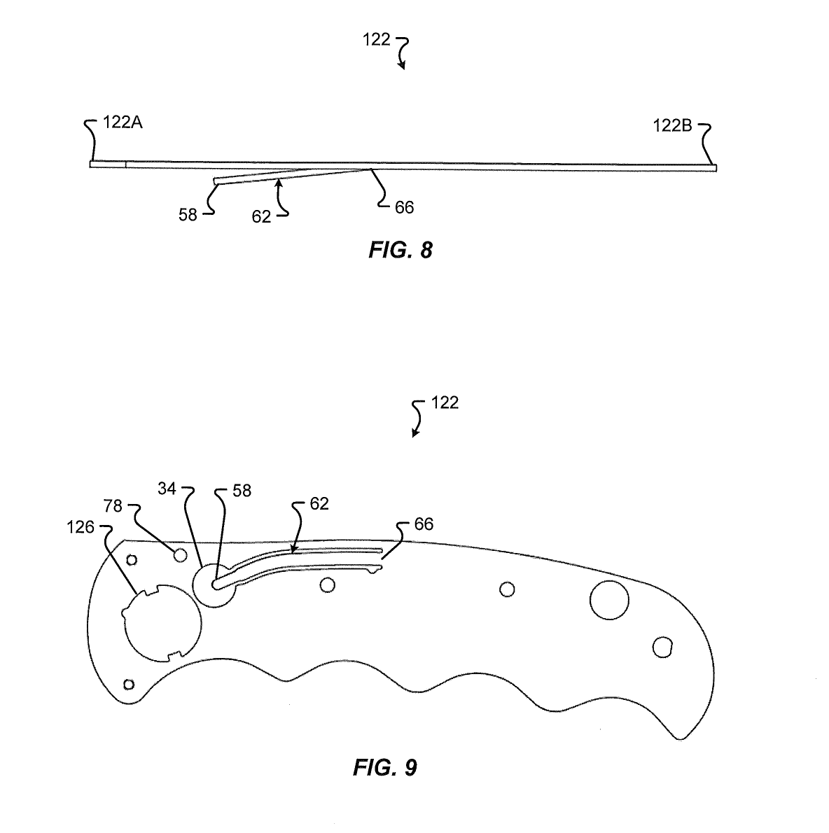

Referring now to FIG. 8, a top plan view of an embodiment of a liner 122 is provided. The depicted liner 122 is generally planar and extends from a first end 122A to a second end 122B. In the depicted embodiment, a biasing member 62 is interconnected to the liner 122 at a fixed end 66. In various embodiments, the biasing member 62 has a length that is substantially less than the liner 122. As can be appreciated, the length of the biasing member 62 can vary depending on the desired force required to laterally displace a second end 58 of the biasing member 62. In the depicted embodiment, the first end 66 is integrally formed in the liner 122 and is coplanar with the liner 122. In alternative embodiments, the biasing member 62 may be interconnected to the liner 122 using methods known in the art, including, but not limited to, adhesives, fasteners, and welding. As depicted, the biasing member is in a non-displaced position and a second end 58 of the biasing member 62 is laterally offset from the first end 66 and the liner 122. As discussed earlier, in an alternative embodiment, a second end 58 of the biasing member 62 may be coplanar with the liner 122 in a non-displaced position. In this alternative embodiment, a recess can be formed in a scale affixed to an outer surface of the liner 122 to accommodate the lateral displacement of the biasing member 62. In some embodiments, a liner 122 is not utilized. In these embodiments, a biasing member 62 is interconnected to a scale in a similar fashion as described above in connection with the liner 122.

Referring back to the embodiment depicted in FIG. 8, the biasing member 62 has a linear profile between the first end 66 and the second end 58. In alternative embodiments, the biasing member 62 may have an arcuate profile between the first end 66 and the second end 58. The biasing member 62 can provide a linear and/or non-linear biasing force to bias the push button 38 laterally relative to the tang 70 of the blade 6.

Referring now to FIG. 9, a front elevation view of an embodiment of a liner 122 is depicted. The biasing member 62 depicted in FIG. 9 is integrally formed, or connected to, the liner 122 at a first end 66. A second end 58 of the biasing member 62 is laterally displaceable relative to the first end 66 of the biasing member 62 in a direction substantially transverse to the liner 122. A button aperture 34 is formed in the liner 122, and is generally associated with a push button 38 that couples to the second end 58 of the biasing member 62. In the depicted embodiment, the biasing member 62 has an arcuate shape, which extends from the first end 66 to the second end 58. As can be appreciated, the shape of the biasing member 62 can vary. Generally, the shape and location of the biasing member 62 allows the biasing member 62 to not interfere with the rotation of the blade 6.

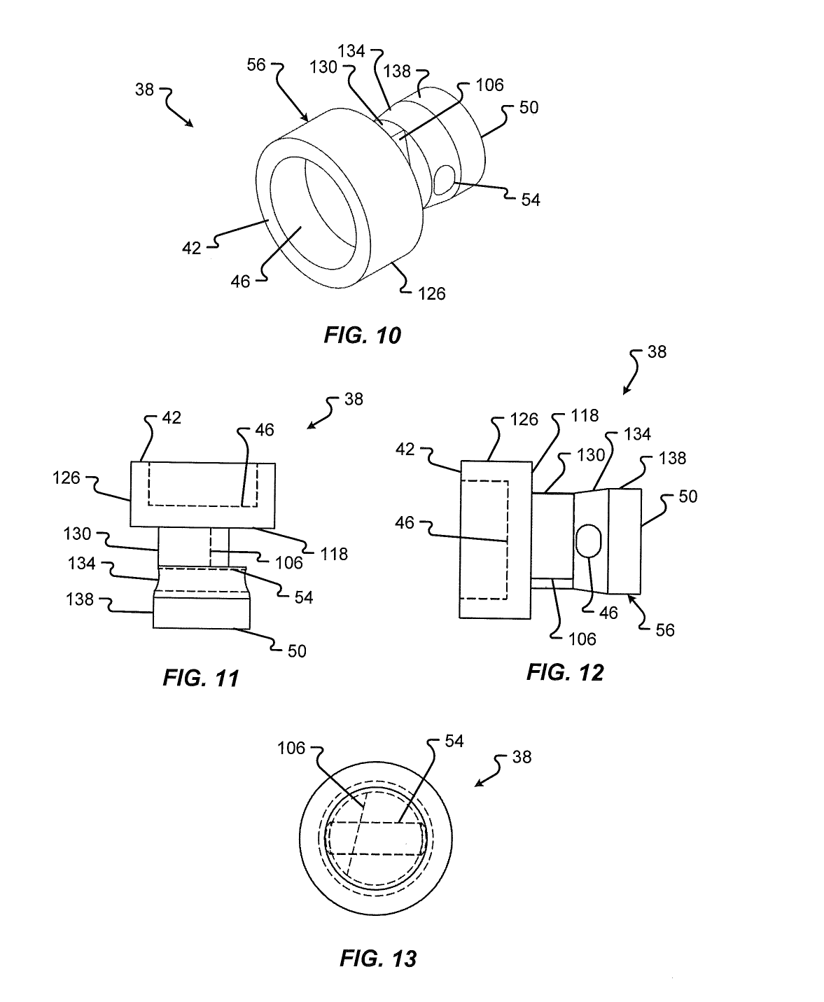

With reference to FIGS. 10-13, one embodiment of a button 38 is provided. The button 38 depicted in FIGS. 10-13 includes a first end 42 with a recess 46 and a second end 50 without a recess. The recess 46 reduces the weight of the button 38 and provides indexing for a user's finger. Between the first end 42 and the second end 50, a sidewall 56 includes a first cylindrical portion 126, a second cylindrical portion 130, a ramp portion 134, and a third cylindrical portion 138. The first cylindrical portion 126 is configured to be disposed at least partially within an aperture 34 formed in a second handle portion 14, and is separated from the second cylindrical portion 130 by an alignment surface 118. A notch 106 is formed in the second cylindrical portion 130 and is configured to allow rotation of a blade 6 when the notch 106 is aligned with a tang 70 of the blade 6. A receiving hole 54 is formed in a ramp portion 134, which may be linear and/or arcuate. In alternative embodiments, the receiving hole 54 may be formed in the third cylindrical portion 138. For example, if the free end 58 of the biasing member 62 is not laterally offset from a fixed end 66 of the biasing member 62, then the receiving hole 54 may be formed in the third cylindrical portion 138. In the depicted embodiments, the receiving hole 54 is a through-hole. However, in alternative embodiments, the receiving hole 54 does not extend through the button 38 and extends a sufficient distance into the button 38 to accommodate a free end 58 of the biasing member 62.

In operation, according to various embodiments, when the button 38 is in a non-displaced position, the ramp portion 134 and/or the third cylindrical portion 138 interacts with the tang 70 of the blade 6 to prevent blade rotation. In a fully depressed position, the alignment surface 118 of the push button 38 abuts the tang 70 of the blade 6. In this position, the notch 106 aligns with the tang 70 and allows rotation of the blade 6. When the blade 6 is rotated between a fully open and a fully closed position, the tang 70 of the blade 6 prevents the biasing member 62 from laterally displacing the button 38 into a locked position. Once in a fully open or closed position, the biasing member 62 laterally displaces the button 38 into a locked position in which a portion of the push button 38 interacts with the tang 70 of the blade to prevent rotation of the blade.

While various embodiments have been described in detail, it is apparent that modifications and alterations of those embodiments will occur to those skilled in the art. For example, embodiments of the locking mechanism disclosed herein can be utilized with any type or form of folding tool or apparatus with a rotatable implement or member. Further, various features of the disclosure have been grouped together in one or more aspects, embodiments, or configurations for the purpose of streamlining the disclosure. However, it should be understood that various features of the certain aspects, embodiments, or configurations of the disclosure may be combined in alternate aspects, embodiments, or configurations. It is to be expressly understood that such modifications and alterations are within the scope and spirit of the claimed invention, as set forth in the following claims.

What is claimed is:

1. A folding knife with a blade locking mechanism, comprising:
a handle comprising a first scale, a second scale, and a liner positioned therebetween, the handle having a forward portion;
a blade at least partially disposed between the first scale and the second scale, the blade having a front end and a rear end, the rear end of the blade having a tang rotatably interconnected to the forward portion of the handle; and
a locking mechanism comprising:
a sidespring having a fixed end integrally connected to the liner and a free end that displaces laterally relative to the fixed end of the sidespring; and
a push button having a sidewall at least partially disposed within the forward portion of the handle, the sidewall coupled to the free end of the sidespring, wherein the sidespring biases the push button towards a locked position in which a portion of the push button interacts with the tang of the blade to prevent rotation of the blade.

2. The folding knife of claim 1, wherein the free end of the sidespring is laterally offset from the liner in a non-displaced position.

3. The folding knife of claim 1, wherein the sidewall of the push button includes a receiving hole, and wherein the free end of the sidespring extends into the receiving hole to couple the push button to the sidespring.

4. The folding knife of claim 1, wherein the push button includes a first end having a recessed portion for indexing with a user's finger.

5. The folding knife of claim 1, wherein at least a portion of the push button extends outwardly from an exterior surface of the handle.

6. The folding knife of claim 1, wherein the forward portion of the handle includes an aperture configured to accommodate the push button.

7. A folding tool with a selective locking mechanism, comprising:
a handle comprising a first handle portion and a second handle portion, the handle having a forward portion and an exterior surface;
an implement at least partially disposed between the first handle portion and the second handle portion, the implement having a tang on a rear end of the implement, the tang rotatably interconnected to the forward portion of the handle; and
a locking mechanism comprising:
a biasing member positioned within the exterior surface of the handle, the biasing member having a first end interconnected to the handle and a second end that displaces laterally relative to the first end of the biasing member; and
an engagement member having a sidewall at least partially disposed within the forward portion of the handle, the sidewall coupled to the second end of the biasing member, wherein the biasing member biases the engagement member towards a locked position in which a portion of the engagement member interacts with the tang of the implement to prevent rotation of the implement.

8. The folding tool of claim 7, wherein the biasing member is integrally formed in the handle.

9. The folding tool of claim 7, wherein the first handle portion comprises a liner and a scale, and wherein the biasing member is integrally formed in the liner.

10. The folding tool of claim 9, wherein the free end of the biasing member is laterally offset from the liner in a non-displaced position.

11. The folding tool of claim 7, wherein the biasing member comprises an arcuate shape that does not interfere with the rotation of the implement, and wherein the biasing member comprises a linear profile between the first end and the second end.

12. The folding tool of claim 7, wherein the biasing member comprises a length substantially less than a length of the handle.

13. The folding tool of claim 7, wherein the sidewall of the engagement member includes a receiving hole, and wherein the second end of the biasing member extends into the receiving hole to couple the engagement member to the biasing member.

14. The folding tool of claim 7, wherein at least a portion of the engagement member extends outwardly from the exterior surface of the handle.

15. The folding tool of claim 7, wherein the handle comprises an aperture configured to accommodate the engagement member.

16. The folding tool of claim 7, wherein the folding tool is a folding knife, and wherein the implement is a blade.

17. A locking mechanism for a folding tool with a rotatable implement and a handle, comprising:
a biasing member having a first end integrally connected to the handle and a second end that displaces laterally relative to the first end; and
an engagement member having a sidewall at least partially disposed within the handle, the sidewall coupled to the second end of the biasing member, wherein the biasing member biases the engagement member towards a locked position in which a portion of the engagement member interacts with the implement to prevent rotation of the implement, and wherein when the engagement member is displaced laterally a predetermined distance, the implement is permitted to rotate.

18. The folding tool of claim 17, wherein the biasing member has an arcuate shape that does not interfere with rotation of the implement, and wherein the biasing member has a linear profile between the first end and the second end.

19. The folding tool of claim 17, wherein the second end of the biasing member is laterally offset from the handle in a non-displaced position.

20. The folding tool of claim 17, wherein the sidewall of the engagement member includes a receiving hole, and wherein the second end of the biasing member extends into the receiving hole to couple the engagement member to the biasing member.

21. The folding tool of claim 17, wherein the engagement member includes a first end having a recessed portion for indexing with a user's finger.

22. The folding tool of claim 17, wherein the folding tool is a folding knife, and wherein the implement is a blade.
